(19) United States
(12) Patent Application Publication
(10) Pub. No.: US 2017/0350920 A1
(43) Pub. Date: Dec. 7, 2017

(54) SCANNING PROBE MICROSCOPE

(71) Applicant: SHIMADZU CORPORATION, Kyoto-shi, Kyoto (JP)

(72) Inventor: Yuichiro IKEDA, Kyoto (JP)

(73) Assignee: SHIMADZU CORPORATION, Kyoto-shi, Kyoto (JP)

(21) Appl. No.: 15/521,118

(22) PCT Filed: Oct. 24, 2014
(86) PCT No.: PCT/JP2014/078310

§ 371 Date: Apr. 21, 2017

(51) Int. Cl. G01Q 10/04

(52) U.S. Cl. CPC G01Q 10/04

(57) ABSTRACT

The invention provides a scanning probe microscope capable of eliminating the influence of vibration noise and obtaining, accurately and with high resolution, surface information of a sample S. A scanning probe microscope 1 includes: a main body unit 10; a control unit 30; and a wireless stand 60 that is connected to the control unit 30 through a power supply signal cable 42 and includes a power supplying coil 63 and a transmission and reception unit 64. The main body unit 10 includes: a cantilever 21 with a probe 21a; a sensor 23 for detecting displacement of the cantilever 21; an XYZ drive mechanism 25 that is controlled by the control unit 30 to move the cantilever 21 or the sample S; a vibration isolation mechanism 12; a power receiving coil 13; and a transmission and reception unit 14 for communicating with the transmission and reception unit 64.

### TECHNICAL FIELD

The present invention relates to a scanning probe microscope for acquiring surface information of a sample on the basis of the interaction between the surface of the sample and the probe, and in particular, to a scanning probe microscope for acquiring surface information of a measured area of a sample.

### BACKGROUND ART

In scanning probe microscopes, a scanner (XYZ drive mechanism) is used to move a probe that is formed in a free end portion of a cantilever in the X direction, the Y direction or the Z direction relative to a sample, or move a sample relative to a probe formed in a free end portion of a cantilever while detecting the interaction that works between the probe and the surface of the sample (amount of displacement of the probe or amount of change in the resonance frequency) so that the shape of the surface (surface information) of a measured area of the sample is obtained with high resolution on the basis of the detected information.

In atomic force microscopes (AFMs), a microscopic atomic force that occurs between the atoms at the tip of the probe and the atoms on the surface of a sample is measured by making a probe supported by a cantilever approach the surface of the sample, and the characteristic where the atomic force is uniquely determined by the distance between the probe and the sample is used while adjusting the distance between the probe and the sample in such a manner that the atomic force between them is kept constant as the probe scans along the surface of the sample so that the uneven shape of the surface of the sample can be measured through the trace of the probe or the sample in the direction of the height.

In scanning tunneling microscopes (STMs), a voltage is applied between a sample and a probe that is arranged so as to face the sample, and the probe or the sample is scanned so that the tunnel current that flows between the two becomes constant, and thus, the shape of the surface of the sample is observed with a resolution at an atomic level. That is to say, the characteristic where the tunnel current is uniquely determined by the distance between the probe and the sample is used while controlling the height of the probe or the sample through a precision drive mechanism such as of a piezoelectric element so that the tunnel current becomes constant, and thus, the unevenness of the surface of the sample can be measured by measuring this amount of control.

FIG. 4 is a perspective diagram showing the configuration of the entirety of a general atomic force microscope (AFM), and FIG. 5 is a schematic diagram showing the configuration of the inside of the atomic force microscope in FIG. 4. Here, the X direction (left and right directions) is one direction that is horizontal to the ground, the Y direction (front and rear directions) is the direction that is horizontal to the ground and perpendicular to the X direction, and the Z direction (upward and downward directions) is the direction that is perpendicular to the X direction and the Y direction.

An atomic force microscope (AFM) 101 is provided with an SPM main body unit 110, a control unit 130 for controlling the entirety of the SPM main body unit 110, a computer 150, a high-voltage cable 141 and a power supply signal cable 42 for connecting the SPM main body unit 110 to the control unit 130, and a signal cable 55 for connecting the control unit 130 to the computer 150.

The SPM main body unit 110 is provided with a housing 111 in approximately a rectangular parallelepiped form and a vibration isolation table (vibration isolation mechanism) 112 in approximately a rectangular parallelepiped form that is formed beneath the housing 111 and arranged between the housing 111 and the floor or the table.

The housing 111 is provided inside with a cantilever holder 22 for supporting a cantilever 21, alight source unit 24 for emitting a laser beam, a displacement measuring unit (sensor) 23 for measuring the displacement of the cantilever 21, a sample placing table 25 on which a sample S is to be placed, and a control circuit 126 for controlling the light source unit 24.

The cantilever 21 is in a plate form having a length of 100 μm, a width of 30 μm and a thickness of 0.8 μm, for example, and has a probe 21a with an acute tip formed so as to protrude downward from the lower surface of an end portion of the cantilever 21. The upper surface of the end portion of the cantilever 21 serves as a reflective surface that is irradiated with a laser beam from the light source unit 24. Thus, the cantilever holder 22 is attached to the head portion (not shown) of the housing 111, and the other end portion of the cantilever 21 is fixed to the cantilever holder 22.

The light source unit 24 is attached to the head portion (not shown) of the housing 111 and is provided with a laser element 24a for emitting a laser beam. The laser beam emitted from the laser element 24a is directed toward the rear surface of the cantilever 21. In addition, the displacement measuring unit 23 is attached to the head portion (not shown) of the housing 111 and is provided with a photodiode 23a for detecting the laser beam reflected from the rear surface of the cantilever 21. At this time, the direction in which light (laser beam) from the rear surface of the cantilever 21 is reflected changes due to the bending (displacement) of the cantilever 21. That is to say, the bending (displacement) of the cantilever 21 can be detected by using an optical lever type optical detector.

The sample placing table 25 is attached in proximity to the center portion of the housing 111 and provided with a placement surface 25a in circular form having a diameter of 15 mm as viewed from the top, for example, and a piezoelectric element (XYZ drive mechanism) 25b that is attached to the lower portion of the placement surface 25a. In addition, the placement surface 25a is movable in the X direction, the Y direction and the Z direction, respectively, relative to the housing 111 by means of the piezoelectric element 25b. As a result, an operator can place a sample S on the placement surface 25a, and at the same time input a drive signal (a high voltage signal of which the amplitude is approximately 200V) to the piezoelectric element 25b from the control unit 130 so that the placement surface 25a can be moved in the X direction, the Y direction and the Z direction relative to the housing 111, and thus, the initial location of the surface of the sample S can be adjusted before measurement. Furthermore, a drive signal can be inputted to the piezoelectric element 25b from the control unit 130 so that the measurement points on the surface of the sample S can be scanned in the X direction, the Y direction and the Z direction during the measurement process.

The control unit 130 is provided with a housing 131 in approximately rectangular parallelepiped form. The inside of the housing 131 is provided with a CPU 132, a memory (storage unit) 133 and a high voltage power supply 134 for supplying a high voltage to a piezoelectric element control unit 132c. In addition, for explanation, the processing functions of the CPU 132 are divided into blocks of an input information acquisition unit 132a for acquiring input information from the below-described input information outputting unit 151a via a signal cable 55, a piezoelectric element control unit 132c for outputting a drive signal to the piezoelectric element 25b via a high voltage cable 141, a displacement signal acquisition unit 132d for acquiring a displacement signal from the control circuit 126 via a power supply signal cable 42, and a sample information outputting unit 132e for outputting the surface shape of the measured area of the sample S (surface information) to the below-described sample information acquisition unit 151b via a signal cable 55.

Here, the memory 133 temporarily stores the acquired displacement signal.

The computer 150 is provided with a CPU 151, a display device and an input device 54. In addition, for explanation, the processing functions of the CPU 151 are divided into blocks of an input information outputting unit 151a for outputting the input information that has been inputted by the input device 54 to the input information acquisition unit 132a via a signal cable 55, a sample information acquisition unit 151b for acquiring the surface shape of the measured area of the sample S (surface information) from the sample information outputting unit 132e via a signal cable 55, and a sample information display control unit 151c for displaying the surface shape of the measured area of the sample S (surface information) on the display device 53.

Incidentally, atomic force microscopes, such as the atomic force microscope 101, allow the surface information of a sample S to be measured with a resolution in an atomic order, and therefore are very susceptible to the effects of noise such as loud sounds and vibrations from the floor or the drive mechanism. Therefore, the SPM main body unit 110 is placed on the vibration isolation table 112 in order to reduce the effects of vibrations from the floor surface (see Patent Literature 1).

### CITATION LIST

### Patent Literature

Patent Literature 1: Japanese Unexamined Patent Publication 2001-21477

### SUMMARY OF INVENTION

### Technical Problem

In the configuration where the housing 111 of the SPM main body unit 110 is placed on the vibration isolation table 112, vibrations can be conveyed to the housing 111 via the high voltage cable 141 or the power supply signal cable 42 that lie on the floor or on the table in the case where the high voltage cable 141 or the power supply signal cable 42 picks up the vibrations from the floor or the table or the control unit 130 vibrates. Thus, the mutual displacement between the cantilever 21 and the sample S is changed when such vibrations affect the cantilever holder 22 or the sample placing table 25, and as a result, the vibrations get mixed in with the displacement signal from the photodiode 23a as vibration noise, and such a problem arises that precise surface information of the sample S cannot be gained due to the effects of the vibration noise.

### Solution to Problem

The present applicant examined a method for gaining surface information on a sample S precisely and with high resolution. First, an idea of changing the high voltage cable 141 and the power supply signal cable 42 to cables with a more flexible material came to mind. However, it is necessary to use cables able to withstand high voltage in order to transmit a high voltage signal of approximately 200V to the SPM main body unit 110 from the control unit 130, and thus, the idea of changing cables could not be adopted at that point in time.

Thus, the high voltage cable 141 and the power supply signal cable 42 for making the connection between the control unit 130 and the SPM main body unit 110 were removed, and instead, it was found that a power supplying coil and a power receiving coil can be provided for wireless power supply, and at the same time, a displacement signal can be transmitted and received through radio wave communication or optical communication. Accordingly, a high voltage signal for driving the piezoelectric element 25b was generated inside the SPM main body unit 110. In this case, the positional relationship between the power supplying coil and the power receiving coil is important, and it was also found that an indicator lamp or a display for displaying the state of the power supply could be provided in order to determine whether or not the positional relationship was appropriate.

That is to say, the scanning probe microscope according to the present invention is provided with: a cantilever having a probe in a free end portion; a sensor that can detect a displacement of the free end portion of the above-described cantilever; an XYZ drive mechanism that can move the above-described cantilever or a sample in the XYZ directions; a main body unit having a vibration isolation mechanism that can remove vibrations; and a control unit that can control the above-described XYZ drive mechanism, and at the same time can acquire surface information of a measured area of the above-described sample, and is characterized by further including: a wireless stand having a power supplying coil and a transmission and reception unit on the stand side; and a power supply signal cable for connecting said wireless stand to said control unit, wherein the above-described main body unit comprises: a high voltage generating circuit that can generate a high voltage signal for driving the above-described XYZ drive mechanism; a power receiving coil to which power can be supplied from the above-described power supplying coil; and a transmission and reception unit on the main body side that can communicate with the above-described transmission and reception unit on the stand side.

In the scanning probe microscope according to the present invention, the control unit and the wireless stand are connected through a power supply signal cable. In addition, the wireless stand and the main body unit are connected in a wireless structure using coils and transmission and reception units. That is to say, no wires are connected to the main body unit at all.

When a signal is inputted from the control unit to the wireless stand via a power supply signal cable, the signal is outputted from the wireless stand to the coil and the transmission and reception unit in the main body unit through the wireless structure. The main body unit into which the signal has been inputted generates a high voltage signal in the high voltage generating circuit so as to control the XYZ drive mechanism. After that, when a signal is inputted from the transmission and reception unit in the main body unit to the transmission and reception unit in the wireless stand through the wireless structure, a signal is outputted from the wireless stand to the control unit via a power supply signal cable in the configuration.

### Advantageous Effects of Invention

As described above, in the scanning probe microscope according to the present invention, the main body unit does not need a cable for external connection, and therefore, no vibrations enter the main body through a cable in the case where rubber supports (vibration isolation mechanisms) are attached to the bottom surface of the main body unit or the main body unit is placed on a vibration isolation table (vibration isolation mechanism). In addition, the handling of the main body is easy because no cables are connected to the main body unit.

### Other Means for Solving Problem and Effects Thereof

In the scanning probe microscope according to the present invention, the above-described control unit may turn off the above-described power supplying coil unless a signal is received from the above-described transmission and reception unit on the main body unit side.

In the scanning probe microscope according to the present invention, a power supply start switch, for example, is pressed in order to start the power supply at that point in time on the power supplying coil side after the wireless stand has been arranged, and it is determined that the power supplying system is defective unless a radio wave response or a signal response is received from the power receiving coil side within a certain period of time, and the power supplying coil is turned off. In addition, a signal indicating a normal operation is monitored at predetermined intervals while the power is being supplied, and the power supplying coil is turned off in the case where the voltage on the power receiving coil side is disconnected due to a shift in the positional relationship.

Furthermore, the scanning probe microscope according to the present invention may have an indicator lamp or a display for displaying the state of the power supply between the above-described power supplying coil and the above-described power receiving coil.

Moreover, in the scanning probe microscope according to the present invention, the above-described XYZ drive mechanism may be a piezoelectric element.

### BRIEF DESCRIPTION OF DRAWINGS

FIG. 1 is a perspective diagram showing an atomic force microscope according to one embodiment of the present invention;

FIG. 2 is a side diagram showing the SPM main body unit and the wireless stand in FIG. 1;

FIG. 3 is a schematic diagram showing the internal configuration of the atomic force microscope in FIG. 1;

FIG. 4 is a perspective diagram showing a conventional atomic force microscope (AFM); and

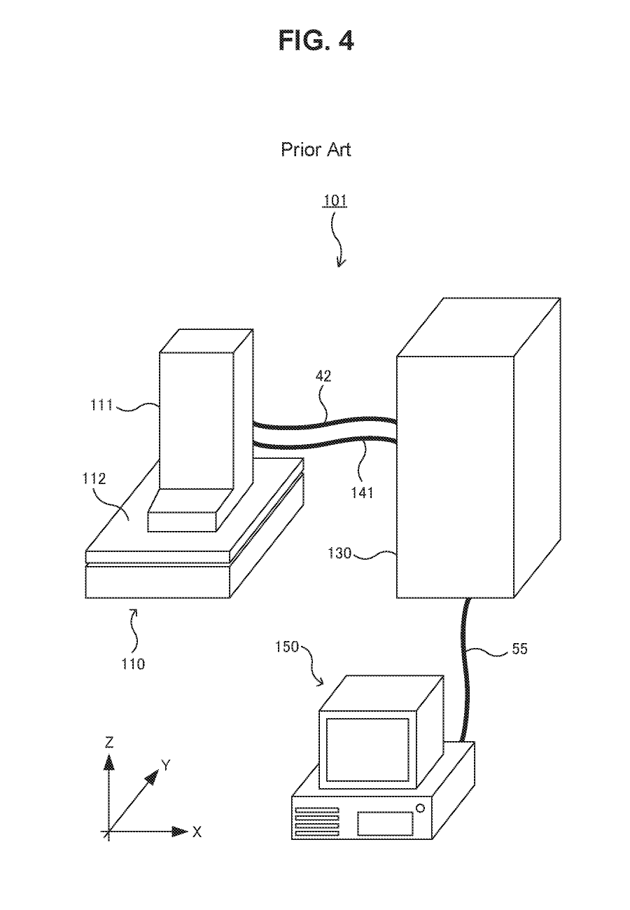

FIG. 5 is a schematic diagram showing the internal configuration of the atomic force microscope in FIG. 4.

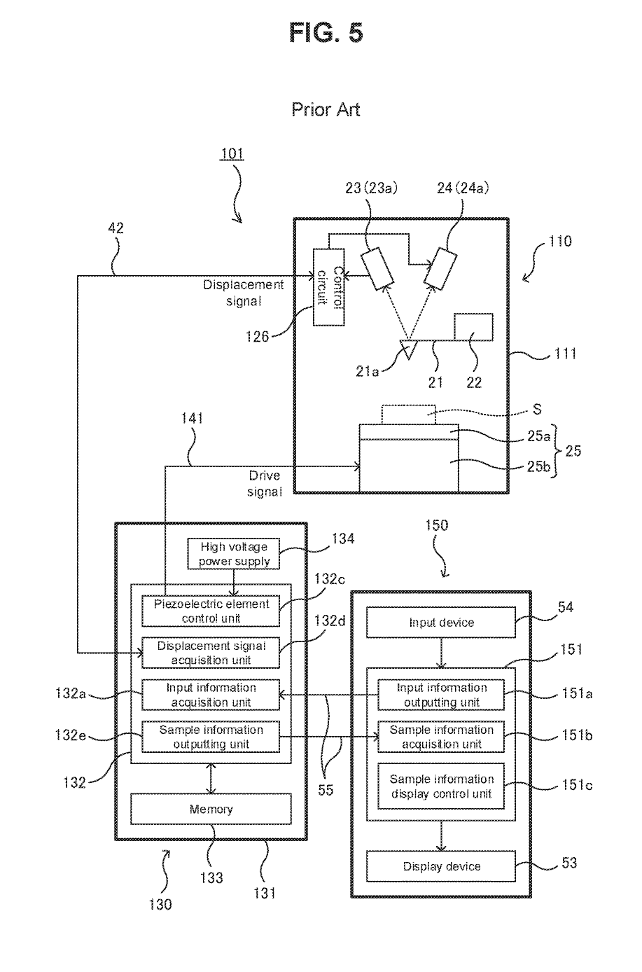

### DESCRIPTION OF EMBODIMENTS

In the following, the embodiments of the present invention are described in reference to the drawings. Here, the present invention is not limited to the below-described embodiments, and needless to say, the invention includes various modifications as long as the gist of the present invention is not deviated from.

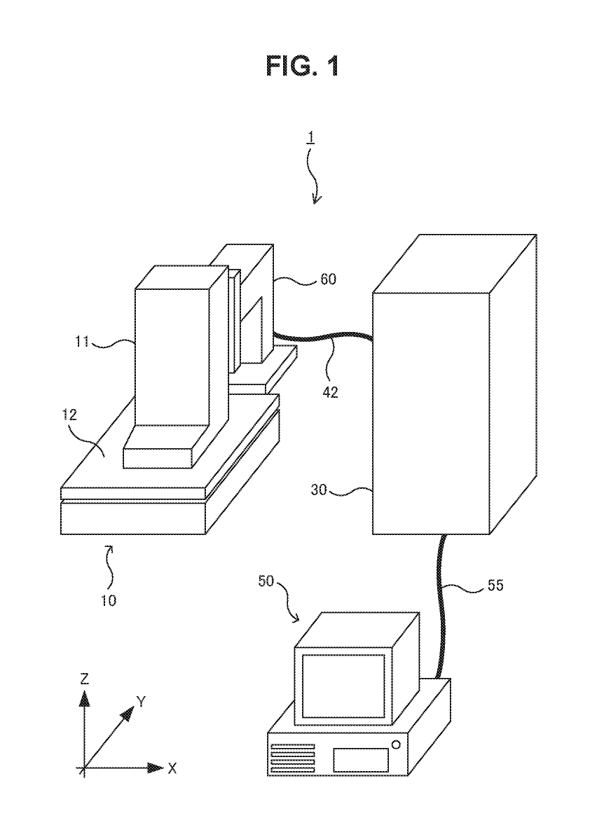

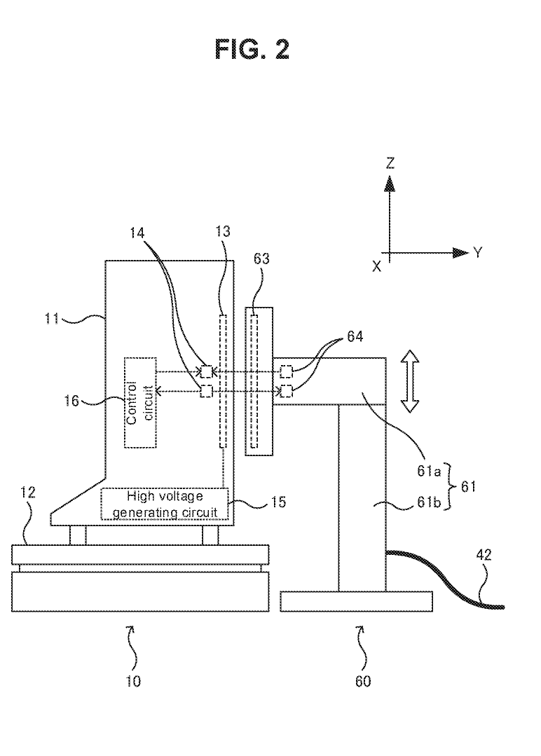

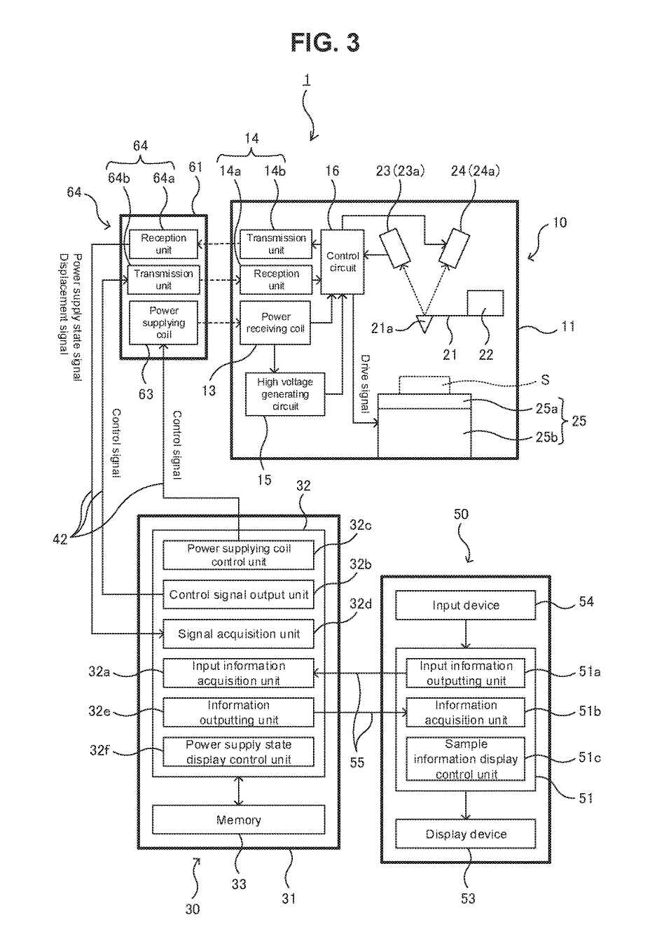

FIG. 1 is a perspective diagram showing the configuration of the entirety of the atomic force microscope according to one embodiment of the present invention. FIG. 2 is a side diagram showing the SPM main body unit and the wireless stand portion in FIG. 1. In addition, FIG. 3 is a schematic diagram showing the internal configuration of the atomic force microscope in FIG. 1. Here, the same symbols are attached to the same components as in the atomic force microscope (AFM) 101.

An atomic force microscope (AFM) 1 is provided with an SPM main body unit 10, a control unit 30 for controlling the entirety of the SPM main body unit 10, a wireless stand 60, a computer 50, a power supply signal cable 42 that connects the wireless stand 60 to the control unit 30, and a signal cable 55 that connects the control unit 30 to the computer 50.

The SPM main body unit 10 is provided with a housing 11 in approximately rectangular parallelepiped form and a vibration isolation table (vibration isolation mechanism) 12 in approximately rectangular parallelepiped form that is formed in the lower portion of the housing 11 so as to be placed between the housing 11 and the floor or the like.

The inside of the housing 11 is provided with: a cantilever holder 22 for supporting a cantilever 21; a light source unit 24 for emitting a laser beam; a displacement measurement unit (sensor) 23 for measuring the displacement of the cantilever 21; a sample placing table 25 on which a sample S is to be placed; a power receiving coil 13; an optical module (a transmission and reception unit on the main body side) 14; a high voltage generating circuit 15 for supplying a high voltage to a control circuit 16; and a control circuit 16 for controlling the light source unit 24 and the sample placing table 25.

The power receiving coil 13 and the optical module 14 are provided in the housing 11 on the rear surface side and connected with the below-described wireless stand 60 through a wireless structure. The optical module 14 is made of a reception unit 14a that optically receives a control signal from a transmission unit 64b and a transmission unit 14b that optically transmits a power supply state signal or a displacement signal to a reception unit 64a, and the power is supplied to the power receiving coil 13 from the power supplying coil 63.

The control circuit 16 controls the light source unit 24 and the sample placing table 25 on the basis of the control signal that has been optically received by the reception unit 14a, and after that acquires a displacement signal from a photodiode 23a so as to optically transmit a displacement signal from the transmission unit 14b, and at the same time determines the amplitude of the voltage of the power receiving coil 13 in order to control the optical transmission of a power supply state signal from the transmission unit 14b. That is to say, a high speed analog signal that exceeds the speed of wireless communication is processed in the control circuit 16 in the SPM main body unit 10.

The sample placing table 25 is attached in proximity to the center portion of the housing 11 and provided with a placement surface 25a in circular form having a diameter of 15 mm as viewed from the top, for example, and a piezoelectric element (XYZ drive mechanism) 25b attached in the lower portion of the placement surface 25a. Thus, the placement surface 25a is movable in the X direction, the Y direction and the Z direction, respectively, relative to the housing 11 by means of the piezoelectric element 25b. As a result, an operator can place a sample S on the placement surface 25a, and at the same time input a drive signal (high voltage signal of which the amplitude is approximately 200V) to the piezoelectric element 25b from the control unit 16 so that the placement surface 25a can be moved in the X direction, the Y direction and the Z direction relative to the housing 11, and thus, the initial location of the surface of the sample S can be adjusted before measurement. Furthermore, a drive signal can be inputted to the piezoelectric element 25b from the control unit 16 so that the measurement points on the surface of the sample S can be scanned in the X direction, the Y direction and the Z direction during the measurement process.

The wireless stand 60 is provided with a housing unit 61 made of an upper housing portion 61a and a lower housing portion 61b. The front surface in the upper housing portion 61a is provided with a power supplying coil 63 for supplying power to the power receiving coil 13 and an optical module transmission and reception unit on the stand side) 64. In addition, the upper housing portion 61a is movable in the upward and downward directions relative to the lower housing portion 61b so that an operator can adjust the height.

The optical module (a transmission and reception unit on the stand side) 64 is made of a transmission unit 64b for optically transmitting a control signal to the reception unit 14a and a reception unit 64a for optically receiving a displacement signal or a power supply state signal from the transmission unit 14b.

Here, the power transmission between the power supplying coil 63 and the power supplying coil 13 may be carried out in accordance with an electromagnetic induction system or a magnetic resonant system. In the case where the housing 11 is used within a thermostatic chamber, a hole through which the front portion of the upper housing unit 61a can be inserted may be provided in a wall of the thermostatic chamber, or the shape of the wireless stand 60 may be changed in accordance with the location of the hole for the conventional high voltage cable 141 or the power supply signal cable 42 that are created in a wall of the thermostatic chamber.

The control unit 30 is provided with a housing 31 in approximately rectangular parallelepiped form, a power supply start switch (not shown) and a state of power supply indicator lamp (not shown), and the inside of the housing 31 is provided with a CPU 32 and a memory (storage unit) 33. In addition, for explanation, the processing functions of the CPU are divided into blocks of an input information acquisition unit 32a for acquiring input information from the below-described input information outputting unit 51a via a signal cable 55 or input information from the power supply start switch, a control signal outputting unit 32b for outputting a control signal to the transmission unit 64b via a power supply signal cable 42, a power supply coil control unit 32c for outputting a control signal to the power supplying coil 63 via a power source signal cable 42, a signal acquisition unit 32d for acquiring a displacement signal or a state of power supply signal from the reception unit 64a via a power supply signal cable 42, an information outputting unit 32e for outputting the surface shape (surface information) of the measured area of the sample S to the below-described information acquisition unit 51b via a signal cable 55, and a state of power supply indication control unit 32f for displaying the state of power supply on a state of power supply indicator lamp (not shown).

The state of power supply indication control unit 32f controls the indicator lamp so as to indicate the state of power supply at the time on the basis of the state of power supply or controls the power supplying coil control unit 32c so as to output a control signal.

For example, the state of power supply indication control unit 32f determines that the power supply system is defective unless an operation normal signal is received in response to the state of power supply at predetermined intervals and outputs a control signal that turns off the power supplying coil 63 to the power supplying coil control unit 32c. As a result, such an accident that the power supply is maintained to a foreign substance other than the power receiving coil 13, which generates heat, can be prevented.

Meanwhile, the state of power supply indication control unit 32f turns on the state of power supply indicator lamp that indicates a normal state in the case where an operation normal signal is received in response to the state of power supply. At this time, a green light is turned on in the case where the mutual positional relationship is optimal judging from the state of power supply, a yellow light is turned on in the case where the positional relationship is slightly less than optimal, and a red light is turned on in the case where the positional relationship is not optimal. As a result, the operator is to adjust the positional shift.

The computer 50 is provided with a CPU 51, a display device 53 and an input device 54. In addition, for explanation, the processing functions of the CPU 51 are divided into blocks of an input information outputting unit 51a for outputting the input information that has been inputted through the input device 54 to the input information acquisition unit 32a via a signal cable 55, an information acquisition unit 51b for acquiring the surface shape (surface information) of the measured area of the sample S from the information outputting unit 32e via a signal cable 55, and a sample information display control unit 51c for displaying the surface shape (surface information) of the measured area of the sample S on the display device 53.

As described above, in the scanning probe microscope 1 according to the present invention, the SPM main body unit 10 does not need a cable for external connection, and therefore, no vibrations enter the SPM main body 10 through a cable. In addition, the handling of the SPM main body 10 is easy because no cables are connected to the SPM main body unit 10.

After the wireless stand 60 has been arranged, the power supply start switch is pressed on the power supplying coil 63 side, for example, in order to start the power supply from that point in time. In the case where an operation normal signal is not received from the power receiving coil 13 side within a certain period of time, however, it is determined that the power supply system is defective and the power supplying coil 63 is turned off. In addition, an operation normal signal is monitored at certain intervals even while the power is being supplied, and the power supplying coil 63 is turned off in the case where the voltage on the power receiving coil 13 side is interrupted due to a shift in the positional relationship.

### Other Embodiments

(1) Though the above-described atomic force microscope 1 has a configuration where the sample placing table 25 is movable in the X direction, the Y direction and the Z direction, such a configuration that the cantilever holder is movable in the X direction, the Y direction and the Z direction may be substituted.

(2) Though the above-described atomic force microscope 1 has a configuration where the bending (displacement) of the cantilever 21 is detected by using an optical lever type optical detection device, a configuration for detecting the bending of the cantilever may be provided by using other methods.

(3) Though the above-described atomic force microscope 1 has a configuration where optical communication is achieved by means of the optical modules 14 and 64, a configuration may be provided where other methods such as transmission through radio waves are used for communication. In the case of transmission through radio waves, the points at which the antennae in the SPM main body unit and the antennae in the wireless stand are positioned in such a manner as to make communication possible.

(4) Though the above-described atomic force microscope 1 has a configuration where the state of power supply indicator lamp indicates the state of power supply, a configuration may be provided where the state of power supply is displayed on a display device of the computer or on the state of power supply indicator lamp provided in the wireless stand.

(5) Though the above-described atomic force microscope 1 has a configuration where the power receiving coil 13 and the optical module 14 are provided in the housing 11 on the rear surface side, and the power supplying coil 63 and the optical module 64 are provided in the upper housing unit 61a on the front surface side, a configuration may be provided where the power receiving coil and the optical module are provided inside the housing on the bottom side, and the power supplying coil and the optical module are provided inside the housing on the top side. In addition, a configuration may be provided where a wall that surrounds the optical path or the entirety of the coil is formed between the optical modules 14 and 64 in order to prevent the optical signal from cross-talking with the ambient light.

### INDUSTRIAL APPLICABILITY

The present invention can be used for scanning probe microscopes that are appropriate for the observation of the surface of a sample.

### REFERENCE SIGNS LIST

1 atomic force microscope (scanning probe microscope)

10 SPM main body unit

12 vibration isolation table (vibration isolation mechanism)

13 power receiving coil

14 optical module (a transmission and reception unit on the main body unit side)

15 high voltage generating circuit

21 cantilever

21a probe

23 displacement measurement unit (sensor)

25 piezoelectric element (XYZ drive mechanism)

30 control unit

42 power supply signal cable

60 wireless stand

63 power supplying coil

64 optical module (transmission and reception unit on the stand side)

1. A scanning probe microscope, comprising: a cantilever having a probe in a free end portion; a sensor that can detect a displacement of the free end portion of said cantilever; an XYZ drive mechanism that can move said cantilever or a sample in the XYZ directions; a main body unit having a vibration isolation mechanism that can remove vibrations; and a control unit that can control said XYZ drive mechanism, and at the same time can acquire surface information of a measured area of said sample, characterized by further comprising:
a wireless stand having a power supplying coil and a transmission and reception unit on the stand side; and
a power supply signal cable for connecting said wireless stand to said control unit, wherein
said main body unit comprises: a high voltage generating circuit that can generate a high voltage signal for driving said XYZ drive mechanism; a power receiving coil to which power can be supplied from said power supplying coil; and a transmission and reception unit on the main body side that can communicate with said transmission and reception unit on the stand side.

2. The scanning probe microscope according to claim 1, characterized in that said control unit turns off said power supplying coil unless a signal is received from said transmission and reception unit on the main body unit side.

3. The scanning probe microscope according to claim 1, characterized by further comprising an indicator lamp or a display that can display the state of the power supply between said power supplying coil and said power receiving coil.

4. The scanning probe microscope according to claim 1, characterized in that said XYZ drive mechanism is a piezoelectric element.
